(19) United States
(12) Patent Application Publication
(10) Pub. No.: US 2015/0019961 A1
(43) Pub. Date: Jan. 15, 2015

(54) PORTABLE TERMINAL AND METHOD FOR CONTROLLING DATA MERGING

(71) Applicant: Samsung Electronics Co., Ltd., Suwon-si (KR)

(72) Inventor: Sung-Joon WON, Seongnam-si (KR)

(21) Appl. No.: 14/329,287

(22) Filed: Jul. 11, 2014

(30) Foreign Application Priority Data
Jul. 11, 2013 (KR) 10-2013-0081733

(51) Int. Cl. G06F 17/24; G06F 17/27

(52) U.S. Cl. CPC G06F 17/24; G06F 17/2765
USPC 715/268

(57) ABSTRACT

A portable terminal and a method for controlling data merging are provided. The method for controlling the data merging includes analyzing input data, extracting and displaying one or more data corresponding to the analyzed input data, and merging at least one data selected from the one or more displayed data and the input data.

### CROSS-REFERENCE TO RELATED APPLICATION(S)

This application claims the benefit under 35 U.S.C. §119(a) of a Korean patent application filed on Jul. 11, 2013 in the Korean Intellectual Property Office and assigned Serial No. 10-2013-0081733, the entire disclosure of which is hereby incorporated by reference.

### TECHNICAL FIELD

The present disclosure relates to a portable terminal. More particularly, the present disclosure relates to a portable terminal and a method for controlling data merging.

### BACKGROUND

In recent years, various services and additional functions that a portable terminal provides are gradually increasing in use. In order to increase an effective value of the portable terminal and meet various demands of users, a variety of applications which can be executed in the portable terminal have been developed. Accordingly, at least several to hundreds of applications may be stored in the portable terminal, such as a smart phone, a cellular phone, a notebook computer, or a tablet Personal Computer (PC), and the like which can be carried and which has a touch screen.

The portable terminal is developing into a multimedia device, so as to provide various multimedia services using a data communication service as well as a voice call service, in order to satisfy user demands. Further, the portable terminal provides various applications including a memo application that receives an input of handwriting or a text from a user.

However, according to the related art, when inputting handwriting or a text and generating data by using the application such as the memo application in the portable terminal, a user occasionally forgets that the same or similar data has been made and stored, and makes the same or similar data in duplicate, so that duplicate contents are made many times, thereby unnecessarily wasting memory.

Accordingly, there is a need at a time point when a user inputs data such as handwriting, a text, and a picture, or the input data is stored, to inform the user of the similar data through extracting and displaying the pre-stored data similar to the input data.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide the at least the advantages described below. Accordingly, an aspect of the present disclosure is to meet the necessity to provide a memo management, by which data input through an application such as a memo application is analyzed and similar data corresponding to the analyzed data is extracted and displayed, so as to make merging or deleting the input data and the extracted data possible.

Therefore, the present disclosure provides a portable terminal and a method for controlling data merging.

Another aspect of the present disclosure is to provide a portable terminal and a method for controlling data merging, which can analyze data input through an application such as a memo application, and extract and display one or more similar data corresponding to the analyzed data.

Another aspect of the present disclosure is to provide a portable terminal and a method for controlling data merging, which can display and store input data in combination with one or more data extracted to correspond to the input data.

In accordance with an aspect of the present disclosure, a method of controlling data merging of a portable terminal is provided. The method includes analyzing input data, extracting and displaying one or more data corresponding to the analyzed input data, and merging at least one data selected from the one or more displayed data and the input data.

In accordance with an aspect of the present disclosure, the method may further include displaying the merged data.

In accordance with an aspect of the present disclosure, the one or more extracted data may be displayed in a descending order of a similarity to the input data.

In accordance with an aspect of the present disclosure, the similarity may be determined through at least one of a keyword, a passage, a tag, a portion of handwriting, a picture attribute, and a place at which the data is input, the at least one of which is extracted from the input data.

In accordance with an aspect of the present disclosure, the one or more extracted data may be displayed when the input data is completely analyzed or the data is completely input.

In accordance with an aspect of the present disclosure, at least one of functions for deleting the corresponding displayed data, merging the corresponding displayed data with the input data, and deleting the input data may be provided for the one or more displayed data.

In accordance with another aspect of the present disclosure, a method of controlling data merging of a portable terminal is provided. The method includes executing an application that receives an input of at least one data of handwriting and a picture, analyzing the data input to the executed application, extracting one or more data in a descending order of a similarity to the input data to correspond to the analysis, and controlling merging of the input data and the one or more extracted data.

In accordance with an aspect of the present disclosure, the method may further include displaying the merged data.

In accordance with an aspect of the present disclosure, the controlling of the merging may include at least one of the merging the input data and the one or more extracted data, deleting the one or more extracted data, and deleting the input data.

In accordance with an aspect of the present disclosure, the one or more extracted data may be the same as or similar to at least one of a keyword, a passage, a tag, a portion of handwriting, a picture attribute, a place at which the data is input, the at leas tone of which is extracted from the input data.

In accordance with an aspect of the present disclosure, the similarity may be determined through at least one of the keyword, the passage, the tag, the portion of the handwriting, the picture attribute, and the place at which the data is input, the at least one of which has been extracted.

In accordance with an aspect of the present disclosure, the method may further include displaying a number of the one or more extracted data.

In accordance with an aspect of the present disclosure, at least one of functions for deleting the corresponding displayed data, for merging the corresponding displayed data with the input data, and for deleting the input data may be provided for the one or more displayed data.

In accordance with an aspect of the present disclosure, the one or more extracted data is to be moved on the application.

In accordance with another aspect of the present disclosure, a portable terminal for controlling data merging is provided. The portable terminal includes a display unit configured to display an application for receiving an input of at least one data of handwriting and a picture, and data input to the application, and a controller configured to analyze the input data, to extract one or more data corresponding to the analyzed data, and to control merging of the input data and the extracted data.

In accordance with an aspect of the present disclosure, the portable terminal may further include a storage unit configured to store the one or more data corresponding to the analyzed data, and the merged data.

In accordance with an aspect of the present disclosure, the controller may display a screen of the display unit, by dividing the screen into an area that displays the one or more extracted data and an area that displays the input data.

In accordance with an aspect of the present disclosure, the controller may extract, through analyzing the input data, the one or more data having a high similarity to the data input from the storage unit.

In accordance with an aspect of the present disclosure, the controller may recognize the input handwriting as a text, and extract handwriting corresponding to the recognized text from the storage unit.

In accordance with an aspect of the present disclosure, the controller may analyze an attribute of the input picture, and extract a picture corresponding to the analyzed attribute from the storage unit.

In accordance with an aspect of the present disclosure, the attribute of the picture may include at least one of a title of the picture, a date when the picture has been drawn, a place at which the picture has been drawn, an object attribute included in the picture, and information on pixels configuring the picture.

In accordance with an aspect of the present disclosure, the application may include a memo application, a diary application, a note application, and a word or document editing application, which are executed in the portable terminal and which are to make the handwriting and the picture.

In accordance with another aspect of the present disclosure, a method of controlling data merging of a portable terminal is provided. The method includes receiving input data, extracting at least one item stored on the portable terminal according to an extent to which the at least one item is similar to the received input data, displaying the at least one extracted item and the input data, and associating at least one of the at least one extracted item with the input data according to user selection.

As described above, the present disclosure provides a portable terminal and a method for controlling data merging, which can prevent similar data from being made, and easily find data related to input data to merge the related data with the input data, through analyzing the data input through an application such as a memo application, and extracting and displaying the similar data corresponding to the analyzed data. Therefore, data such as a memo can be more efficiently managed.

Further, according to the various embodiments of the present disclosure, because the similar data is prevented from being made, a memory can be more efficiently managed.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating a portable terminal according to various embodiments of the present disclosure;

FIG. 2 illustrates a front view of a portable terminal according to an embodiment of the present disclosure;

FIG. 3 illustrates a rear view of the portable terminal according to an embodiment of the present disclosure;

FIG. 4 illustrates an input unit and an internal structure of a touch screen according to an embodiment of the present disclosure;

FIG. 5 is a block diagram illustrating an input unit according to an embodiment of the present disclosure;

FIG. 6 is a flowchart illustrating a method of controlling data merging according to an embodiment of the present disclosure;

FIG. 7A illustrates an example of an application according to an embodiment of the present disclosure;

FIG. 7B illustrates an example of a process for inputting data to an application according to an embodiment of the present disclosure;

FIG. 7C illustrates an example of a process for inputting data to an application according to an embodiment of the present disclosure;

FIG. 7D illustrates an example of one or more data corresponding to data input to an application according to an embodiment of the present disclosure;

FIG. 7E illustrates an example of a process for adding an arbitrary picture to data input to an application according to an embodiment of the present disclosure; and

FIG. 7F illustrates an example of a process for adding an arbitrary text to data input to an application according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used in this application is for the purpose of describing particular various embodiments only and is not intended to be limiting of the present disclosure. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an operation principle of various embodiments of the present disclosure will be described in detail with reference to the accompanying drawings. In the following description of the present disclosure, a detailed description of known functions and configurations incorporated herein will be omitted when it may make the subject matter of the present disclosure rather unclear. The terms which will be described below are terms defined in consideration of the functions in the present disclosure, and may be different according to users, intentions of the users, or customs. Therefore, its definition will be made based on the overall contents of this specification.

Terms to be used in the present disclosure will be defined as follows:

A portable terminal is a mobile terminal which can be carried. The portable terminal may be a mobile terminal through which data transmission/reception and voice/video calls can be made, and may include at least one touch screen. The portable terminal may include a smart phone, a smart camera, a tablet Personal Computer (PC), a mobile phone, a video phone, an e-book reader, a laptop PC, a netbook PC, a Personal Digital Assistant (PDA), a Portable Multimedia Player (PMP), an mp3 player, a mobile medical device, and the like.

Although a description of various embodiments of the present disclosure is made in relation to a portable terminal, various embodiments of the present disclosure may be applied to a terminal.

According to various embodiments of the present disclosure, a terminal may be a smart home appliance with communication functionality. A smart home appliance may be, for example, a television, a Digital Video Disk (“DVD”) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a three Dimensional Television (3D-TV), a smart TV, a Light Emitting Diode (LED) TV, a Liquid Crystal Display (LCD) TV, a gaming console, an electronic dictionary, an electronic key, a camcorder, an electronic picture frame, and/or the like.

According to various embodiments of the present disclosure, a terminal may be a medical device (e.g., Magnetic Resonance Angiography (MRA) device, a Magnetic Resonance Imaging (MRI) device, Computed Tomography (“CT”) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, a terminal may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

An input unit may include at least one of an electronic pen, which may provide a command or an input to the portable terminal in a contact state on a touch screen or a non-contact state such as hovering over the touch screen, a digital pen, a pen through which near field communication can be made, a pen through which a ultrasonic wave can be detected, a pen employing an optical sensor, a joystick, a stylus pen, and/or the like.

An object, that is displayed or may be displayed on the touch screen of the portable terminal, may include at least one of an application, a Graphical User Interface (GUI), a document, a widget, a photograph, a map, a moving image, an e-mail, a Short Message Service (SMS) message, and a Multimedia Message Service (MMS) message, and may be executed, deleted, cancelled, stored, and changed by the input unit. The object may also be used as a comprehensive meaning that includes a shortcut icon, a thumbnail image, and a folder storing at least one object in the portable terminal

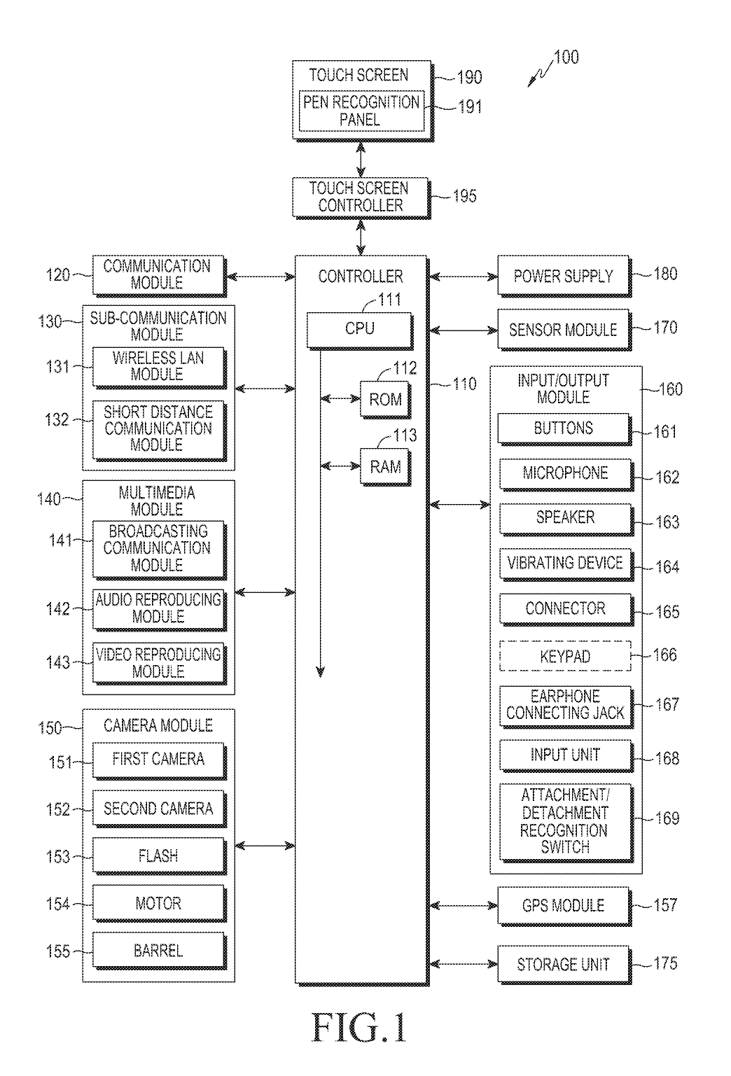

FIG. 1 is a block diagram schematically illustrating a portable terminal according to various embodiments of the present disclosure.

Referring to FIG. 1, a portable terminal 100 may include a controller 110, a communication module 120, a sub-communication module 130, a multimedia module 140, a camera module 150, a GPS module 157, an Input/Output (I/O) module 160, a sensor module 170, a power supply 180, a touch screen 190, and a touch screen controller 195.

The portable terminal 100 can be connected with an external device (not shown) by using one of the mobile communication module 120, the sub-communication module 130, a connector 165, an earphone connecting jack 167, and/or the like. The external device includes various devices detachably attached to the portable terminal 100 through a cable, such as an earphone, an external speaker, a Universal Serial Bus (USB) memory, a charger, a cradle/dock, a DMB antenna, a mobile payment related device, a health management device (blood sugar tester or the like), a game machine, a car navigation device, and/or the like. Further, the electronic device includes a Bluetooth communication device, a Near Field Communication (NFC) device, a WiFi Direct communication device, and a wireless Access Point (AC) which can be wirelessly connected.

The portable terminal 100 may be connected with other devices, such as, for exapmle, a cellular phone, a smart phone, a tablet Personal Computer (PC), a desktop Personal Computer (PC), a server, and/or the like in a wired or wireless manner.

According to various embodiments of the present disclosure, the portable terminal 100 includes at least one touch screen 190 and at least one touch screen controller 195.

The sub-communication module 130 includes at least one of a wireless LAN module 131 and a short distance communication module (e.g., a local area communication module) 132.

The multimedia module 140 includes at least one of a broadcasting communication module 141, an audio reproducing module 142, and a moving image reproducing module 143.

The camera module 150 includes at least one of a first camera 151 and a second camera 152. Further, according to various embodiments of the present disclosure, the camera module 150 may include at least one of a barrel 155 for zooming in/zooming out the first and/or second cameras 151 and 152, a motor 154 for controlling a motion of the barrel 155 to zoom in/zoom out the barrel 155, and a flash 153 for providing a light source for photographing according to a purpose and/or configuration of the portable terminal 100.

The input/output module 160 includes at least one of a button 161, a microphone 162, a speaker 163, a vibration device 164, a connector 165, a keypad 166, an earphone connecting jack, an input unit 168, an attachment/detachment recognition switch, and/or the like.

The controller 110 may include a CPU 111, a Read-Only Memory (ROM) 112 which stores control programs for controlling the portable terminal 100, and a Random Access Memory (RAM) 113 which stores signals or data input from the outside of the portable terminal 100 or is used as a memory region for an operation executed in the portable terminal 100. According to various embodiments of the present disclosure, the CPU 111 may include a various number of cores. For example, the CPU 111 may include a single core, a dual core, a triple core, a quad core, or the like. The CPU 111, the ROM 112 and the RAM 113 may be connected with each other through internal buses.

The controller 110 can control the mobile communication module 120, the sub communication module 130, the multimedia module 140, the camera module 150, the GPS module 157, the input/output module 160, the sensor module 170, the storage unit 175, the power supply 180, the touch screen 190, and the touch screen controller 195.

The controller 110 may determine whether a hovering event, occurring as various input units 168 closely access any one of a plurality of objects while the objects are displayed on the touch screen 190, is recognized, and identify the object corresponding to a location at which the hovering event has occurred. The controller 110 may detect a height from the portable terminal 100 to the input unit, and a hovering input event according to the height, in which the hovering input event may include at least one of a press of a button formed in the input unit, a tap on the input unit, a movement of the input unit at a speed higher than a predetermined speed, and a touch on an object.

The controller 110 may analyze data input on the touch screen, extract one or more data corresponding to the analyzed data, and display the one or more extracted data on the touch screen 190. The controller 110 may merge (or add or combine) the input data and at least one data selected from the one or more displayed data, and store the input data and the selected data, which have been merged, and/or display the input data and the selected data, which have been merged, on the touch screen 190. The controller 110 may simultaneously execute at least two applications for merging the input data and the selected data, and merge or combine the input data and the selected data through the respective applications. Further, the controller 110 may display the number of the extracted data on the touch screen. At least one of functions for deleting the corresponding extracted data, merging the corresponding extracted data with the input data, and deleting the input data may be provided for the one or more extracted data. The input data may include at least one of handwriting, a text, a picture, and the like.

The controller 110 may display the one or more extracted data in a descending order of a similarity to the input data at a partial area of the touch screen 190. The controller 110 may analyze attributes according to the type of the input data on the touch screen 190. The controller 119 may analyze handwriting after transforming the handwriting into a text, in a case in which the input data is the handwriting, and analyze at least one of a title of a picture, a date when the picture was drawn, a place at which the picture was drawn, object attributes included in the picture, and information on pixels configuring the picture, in a case in which the input data is a picture. The controller 110 may extract, from the storage unit 175, one or more data related to the analysis result of the input data. The controller 110 may extract the data from the storage unit 175, storing a plurality of related data, through a keyword, a passage, a tag, a portion of handwriting, a title of a picture, a date when the picture was drawn, a place at which the picture was drawn, object attributes included in the picture, and pixel information configuring the picture, which are included in the input data. According to various embodiments of the present disclosure, the similarity is determined through at least one of the keyword, the passage, the tag, the portion of the handwriting, the picture attributes, attributes of a photo or a picture which is input on the touch screen, location information of a place at which the data is input, and the like. The controller 110 may display the one or more extracted data on the touch screen 190 when the input data has been completely analyzed or the data has been completely input. According to various embodiments of the present disclosure, the one or more data extraction corresponding to the input data may be performed while the data is being input, or after the data is completely input and before the input data is stored.

Further, the controller 110 may execute an application for receiving an input of at least one data of handwriting, a text, and a picture, and analyze the data input to the executed application. The controller 110 may extract one or more data to correspond to the analysis, in which the same data as a keyword extracted from the input data is first extracted and then the similar data to the keyword is extracted in a descending order of a similarity, and control merging of the input data and the one or more extracted data. The controller 110 may display the merged data on the touch screen 190, and/or store the merged data in the storage unit 175. At least one of functions for deleting the corresponding extracted data, merging the corresponding extracted data with the input data, and deleting the input data may be provided for the one or more extracted data. Further, the controller 110 may control at least one of the merging of the input data and the one or more extracted data, the deleting of the one or more extracted data, and the deleting of the input data. The one or more extracted data is the same as or similar to at least one of the keyword, the passage, the tag, the portion of the handwriting, the picture attributes, and the place where the data is input, which are extracted from the input data. According to various embodiments of the present disclosure, the similarity is determined through at least one of the keyword, the passage, the tag, the portion of the handwriting, the picture attributes, the place, and the like which have been extracted. Furthermore, the controller 110 may display the number of the one or more extracted data on the touch screen, and display data corresponding to the number on the touch screen 190. The controller 110 may adjust the number of the extracted data according to a user selection or a threshold value set in advance. Moreover, the controller 110 may control the one or more extracted data to move on the application.

The controller 110 analyzes the input data on the touch screen 190, extracts the one or more data corresponding to the analyzed data, and controls merging of the extracted data and the input data. The controller 110 divides a screen of the touch screen 190 into an area (e.g., a display screen) for displaying the one or more extracted data and an area (e.g., an input screen) for receiving the input of the data or displaying the input data. The controller 110 may extract a keyword through analyzing the input data, extract, from the storage unit 175, one or more data that is the same as or very similar to the extracted keyword, and display the number of the one or more extracted data on the display screen. The controller 110 may recognize handwriting input on the touch screen 190 as a text, transform the handwriting to the text, and extract the handwriting corresponding to the recognized text from the storage unit 175. The controller 110 may analyze attributes of an input picture, and extract the picture corresponding to the analyzed attributes from the storage unit 175. The attributes of the picture may include at least one of a picture title, a date when the picture was drawn, a place at which the picture was drawn, object attributes included in the picture, information on pixels configuring the picture. The controller 110 may transform the handwriting, input to the application for receiving the input of the data, to the text, and analyze the attributes of the input picture. The application may include various programs, which may operate in the portable terminal 100 and receive, from a user, an input of various data including a text, a character string, a picture, and a photo, as well as a word or document editing application, and a memo application, a diary application and a note application in which handwriting and a picture may be made, and/or the like.

The mobile communication module 120 enables the portable terminal 100 to be connected with the external device through mobile communication by using one antenna or a plurality of antennas according to a control of the controller 110. The mobile communication module 120 can transmit/receive a wireless signal for voice communication, video communication, a Short Message Service (SMS), or a Multimedia Message service (MMS) to/from a mobile phone (not shown), a smart phone (not shown), a tablet PC, or another device (not shown) having a phone number input into the display device.

The sub-communication module 130 may include at least one of the wireless LAN module 131 and the short-distance communication module (e.g., local area communication module) 132. For example, the sub-communication module 130 may include only the wireless LAN module 131, only the short-distance communication module (e.g., the local area communication module) 132, or both the wireless LAN module 131 and the short-distance communication module (e.g., the local area communication module) 132.

The wireless LAN module 131 can be Internet-connected according to a control of the controller 110 in a place at which a wireless Access Point (AP) (not shown) is installed. The wireless LAN module 131 supports the wireless LAN standard (IEEE802.11x) of the Institute of Electrical and Electronic Engineers (IEEE). The short-distance communication module (e.g., the local area communication module) 132 may enable local area communication wirelessly between the portable terminal 100 and an image forming apparatus (not illustrated) according to the control of the controller 110. A short distance communication scheme may include Bluetooth, Infrared Data Association (IrDA) communication, WiFi-Direct communication, Near Field Communication (NFC), and the like.

According to the performance and/or configuration of the portable terminal 100, the portable terminal 100 may include at least one of the mobile communication module 120, the wireless LAN module 131, and the short-distance communication module (e.g., the local area communication module) 132. Further, according to the performance and/or configuration of the portable terminal 100, the portable terminal 100 may include a combination of the mobile communication module 120, the wireless LAN module 131, and the short-distance communication module (e.g., the local area communication module 132). According to varoius embodiments of the present disclosure, at least one or combinations of the mobile communication module 120, the wireless Local Area Network (LAN) module 131, and the short-distance communication module (e.g., a local area or near field communication module) 132 are referred to as a transmitter/receiver, without limiting the scope of the present disclosure. Further, the transmitter/receiver may include the touch screen 190.

The multimedia module 140 may include the broadcasting communication module 141, the audio reproducing module 142, and/or the moving image reproducing module 143. The broadcasting communication module 141 can receive a broadcasting signal (e.g., a TV broadcasting signal, a radio broadcasting signal, a data broadcasting signal, and/or the like) and broadcasting supplement information (e.g., an Electric Program Guide (EPG), an Electric Service Guide (ESG), and/or the like) output from a broadcasting station through a broadcasting communication antenna (not shown) according to a control of the controller 110. The audio reproduction module 142 can reproduce a digital audio file (e.g., a file having a file extension of mp3, wma, ogg, way, and/or the like) stored or received according to a control of the controller 110. The moving image reproducing module 143 may reproduce a stored or received digital moving image file (e.g., a file of which the file extension is mpeg, mpg, mp4, avi, mov, mkv, and/or the like) according to the control of the controller 110. The moving image reproducing module 143 may reproduce a digital audio file.

The multimedia module 140 may include the audio reproduction module 142 and the video reproduction module 143 except for the broadcasting communication module 141. Further, the audio reproduction module 142 or the video reproduction module 143 of the multimedia module 140 may be included in the controller 110.

The camera module 150 may include at least one of the first camera 151 and the second camera 152 each of which photographs a still image or a moving image according to the control of the controller 110. Further, the camera module 150 may include at least one of a barrel 155 performing a zoom in/zoom out for photographing a subject, a motor 154 for controlling a motion of the barrel 155, a flash 153 for providing a light source required for photographing the subject, and the like. According to various embodiments of the present disclosure, the first camera 151 may be disposed on a front surface of the apparatus 100, and the second camera 152 may be disposed on a back surface of the apparatus 100. According to various embodiments of the present disclosure, the first camera 151 and the second camera 152 may be disposed to be adjacent to each other (e.g., an interval between the first camera 151 and the second camera 152 is larger than 1 cm or smaller than 8 cm), and thus a three-dimensional still image or a three-dimensional video may be photographed.

Further, each of the first camera 151 and the second cameras 152 includes a lens system, an image sensor, and the like. The first camera 151 and the second camera 152 convert an optical signal input (or photographed) through the lens system to an image signal and output the converted image signal to the controller 110. The user can photograph (e.g., capture) a video or a still image through the first camera 151 and the second camera 152.

The GPS module 157 can receive radio waves from a plurality of GPS satellites (not shown) in Earth's orbit and calculate a position of the portable terminal 100 by using Time of Arrival from the GPS satellites to the portable terminal 100.

The I/O module 160 includes at least one of a button 161, a microphone 162, a speaker 163, a vibration motor 164, a connector 165, a keypad 166, an earphone connecting jack 167, an input unit 168, and/or the like. Further, the I/O module 160 is not limited to the above description, and a cursor control, such as a mouse, a trackball, a joystick, a cursor direction keys, and/or the like may be provided for controlling a motion of a cursor on the touch screen 190.

A plurality of buttons 161 may be formed on the front surface, side surfaces or rear surface of the housing of the portable terminal 100 and may include at least one of a power/lock button (not illustrated), a volume button (not illustrated), a menu button, a home button, a back button, a search button, and the like.

The microphone 162 receives an input of voice or sound to produce an electrical signal according to the control of the controller 110.

The speaker 163 may output sounds which respectively correspond to various signals of the mobile communication module 120, the sub-communication module 130, the multimedia module 140, and the camera module 150 (e.g., a radio signal, a broadcasting signal, a digital audio file, a digital moving image file, photographing), the like to the external environment of the portable terminal 100 according to the control of the controller 110. The speaker 163 can output a sound (e.g., a button tone corresponding to phone communication, a ringing tone, a voice of another user, and/or the like) corresponding to a function performed by the portable terminal 100. One speaker 163 or a plurality of speakers 163 may be formed on a suitable position or positions of the housing of the portable terminal 100.

The vibration motor 164 can convert an electrical signal to a mechanical vibration according to a control of the controller 110. For example, when the portable terminal 100 set to a vibration mode receives a voice call from any other apparatus (not illustrated), the vibration motor 164 is operated. One or more vibration motors 164 may be provided in the housing of the mobile apparatus 100. The vibration motor 164 may operate in response to a touch action of the user on the touch screen 190 and successive motions of touches on the touch screen 190.

The connector 165 may be used as an interface for connecting the apparatus with an external device (not shown) or a power source (not shown). The portable terminal 100 can transmit or receive data stored in the storage unit 175 of the portable terminal 100 to or from an external device (not shown) through a wired cable connected to the connector 165 according to a control of the controller 110. Further, the portable terminal 100 can receive power from the power source through the wired cable connected to the connector 165 or charge a battery (not shown) by using the power source.

The keypad 166 can receive a key input from the user for the control of the portable terminal 100. The keypad 166 may include a physical keypad (not shown) formed in the portable terminal 100 or a virtual keypad (not shown) displayed on the touch screen 190. The physical keypad (not shown) formed in the portable terminal 100 may be excluded according to a capability or structure of the portable terminal 100.

Earphones (not shown) may be inserted into the earphone connecting jack 167 to be connected to the portable terminal 100, and the input unit 168 may be inserted into and preserved in the portable terminal 100 and may be extracted or detached from the portable terminal 100 when being used. In addition, an attachment/detachment recognition switch 169 operating in response to attachment or detachment of the input unit 168 is provided at one area within the portable terminal 100 into which the input unit 168 is inserted, and provides a signal corresponding to the attachment or detachment of the input unit 168 to the controller 110. An attaching/detaching recognition switch 169 may be installed at an area of the portable terminal 100 into which the input unit 168 is inserted, and may directly or indirectly contact the input unit 168 when the input unit 168 is mounted. Accordingly, the attaching/detaching recognition switch 169 may generate a signal corresponding to mounting or detaching of the input unit 168 based on the direct or indirect contact with the input unit 168, and provide the generated signal to the controller 110.

The sensor module 170 includes at least one sensor for detecting a state of the portable terminal 100. For example, the sensor module 170 may include a proximity sensor that detects a user's proximity to the portable terminal 100, an illumination sensor (not illustrated) that detects a quantity of light around the portable terminal 100, a motion sensor (not illustrated) that detects a motion (e.g., rotation of the portable terminal 100 and acceleration or a vibration applied to the portable terminal 100) of the portable terminal 100, a geo-magnetic sensor (not illustrated) that detects a point of a compass by using Earth's magnetic field, a gravity sensor that detects an action direction of the Gravity, an altimeter that detects an altitude through measuring an atmospheric pressure, and/or the like. At least one sensor may detect the state of the portable terminal 100, generate a signal corresponding to the detection, and transmit the generated signal to the controller 110. The sensor of the sensor module 170 may be added or omitted according to a capability of the portable device 100.

The storage unit 175 may store signals or data input/output in response to the operations of the mobile communication module 120, the sub-communication module 130, the multimedia module 140, the camera module 150, the GPS module 157, the input/output module 160, the sensor module 170, and the touch screen 190 according to the control of the controller 110. The storage unit 175 may store a control program for control of the portable terminal 100 or the controller 110, and applications, including a memo application, a diary application, a note application, and a word or document editing application, which can receive an input of data through the touch screen 190, and may store data input through such applications.

The term “storage unit” may include the storage unit 175, the ROM 112 and the RAM 113 within the controller 110, or a memory card (e.g., an SD card or a memory stick) installed in the portable terminal 100. Further, the storage unit 175 may include a nonvolatile memory, a volatile memory, a Hard Disk Drive (HDD), a Solid State Drive (SSD), and/or the like.

The storage unit 175 may store applications with various functions such as navigation, a video call, a game, and a time based alarm, images for providing a Graphic User Interface (GUI) related to the applications, databases or data related to a method of processing user information, a document, and a touch input, background images (a menu screen and a waiting screen) or operating programs necessary for driving the portable terminal 100, and images photographed by the camera module 150. The storage unit 175 is a non-transitory machine-readable (e.g., computer-readable) medium, and the term of the non-transitory machine-readable medium may be defined as a medium for providing data to the machine to perform a specific function. The non-transitory machine-readable medium may be a storage medium. The storage unit 175 may include a non-volatile medium and a volatile medium. All of these media should be a type that allows the commands transferred by the media to be detected by a physical instrument in which the machine reads the commands into the physical instrument.

The non-transitory machine readable medium, without being limited thereto, may include at least one of a floppy disk, a flexible disk, a hard disk, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), a Flash-EPROM, and the like.

The power supply 180 can supply power to one battery or a plurality of batteries (not shown) arranged at the portable terminal 100 according to a control of the controller 110. The one battery or the plurality of batteries (not shown) supply power to the portable terminal 100. In addition, the power supply 180 may supply the power input from the external power source (not illustrated) through a wired cable connected with the connector 165. In addition, the power supply 180 can supply power wirelessly input from the external power source through a wireless charging technology to the portable terminal 100.

Further, the portable terminal 100 may include at least one touch screen 190 providing user interfaces corresponding to various services (e.g., a phone call, data transmission, broadcasting, photography, and/or the like) to the user. Each touch screen 190 may transmit an analog signal corresponding to at least one touch input to a user interface to a corresponding touch screen controller 195. The portable terminal 100 may include a plurality of touch screens 190, and each of the touch screens 190 may be provided with a touch screen controller 195 that receives an analog signal corresponding to a touch. Each touch screen 190 may be connected to a plurality of housings through a hinge, respectively, or may be located in a single housing without a hinge connection. As described above, the portable terminal 100 according to the present disclosure may include at least one touch screen 190, and for convenience of description, one touch screen will be described hereinafter.

The touch screen 190 can receive at least one touch through a user's body (e.g., fingers including a thumb) or a touchable input means (e.g., a finger including a thumb). Further, when a touch is input through a pen such as a stylus pen, an electronic pen, and/or the like, the touch screen 190 includes a pen recognition panel 191 that recognizes the touch input, and the pen recognition panel 191 may grasp a distance between the pen and the touch screen 190 through a magnetic field. In addition, the touch screen 190 may receive a continuous motion of one touch among at least one touch. The touch screen 190 can output an analog signal corresponding to the successive motions of the input touch to the touch screen controller 195.

According to various embodiments of the present disclosure, the touch is not limited to contact between the touch screen 190 and the user's body or the touchable input unit, and may include non-contact (e.g., the touch may be detected without the contact between the touch screen 190 and the user's body or the touchable input unit). A detectable interval in the touch screen 190 may be varied according to a performance, a structure, and/or configuration of the portable terminal 100, and more particularly, the touch screen 190 is configured such that values detected by a touch event and a hovering event (e.g., values including a voltage value or a current value as an analog value) may be output differently from each other, in order to differently detect the touch event through the contact between the touch screen and the user's body or the touchable input unit, and the input event in a non-contact state (e.g., a hovering event). Preferably, the touch screen 190 differently outputs detected values (e.g., current values) according to a distance between a space at which the hovering event occurs and the touch screen 190.

The touch screen 190 may be implemented in, for example, a resistive type, a capacitive type, an infrared type, an acoustic wave type, and/or the like.

The touch screen 190 may include at least two touch screen panels, which can detect touches or close access through the user's body and the touchable input unit, respectively, in order to sequentially or simultaneously receive the inputs through the user's body and the touchable input unit. The at least two touch screen panels may provide mutually different output values to the touch screen controller 195, and the touch screen controller 195 may differently recognize the values input from the at least two touch screen panels and identify whether the input from the touch screen 190 corresponds to the input through the user's body or the input through the touchable input unit. The touch screen 190 may display one or more objects.

More specifically, the touch screen 190 may be formed with a structure in which a panel that detects an input through the input unit 168 by using a change in an induced electromotive force and a panel that detects contact through a finger on the touch screen are attached to each other, or are spaced slightly apart from each other and stacked on one another. The touch screen 190 may include a plurality of pixels, and may display an image through the pixels. The touch screen 190 may use a Liquid Crystal Display (LCD), an Organic Light Emitting Diode (OLED), a Light Emitting Diode (LED), and/or the like.

The touch screen 190 includes a plurality of sensors that detects a location of the input unit 168 when the input unit 168 contacts a surface of the touch screen 190 or is spaced apart from the touch screen 190 at a predetermined distance. The plurality of sensors may be formed with a coil structure, and in a sensor layer formed of the plurality of sensors, the sensors are arranged in a predetermined pattern and form a plurality of electrode lines. Due to the structure as described above, when contact or a hovering input occurs through the input unit 168, a detection signal whose waveform is changed on account of a magnetic field between the sensor layer and the input unit may be generated, and the touch screen 190 may transmit the generated detection signal to the controller 110. Further, when contact occurs through a finger on the touch screen 190, the touch screen 190 transmits, to the controller 110, a detection signal caused by an electrostatic capacity. A distance between the input unit 168 and the touch screen 190 may be apprehended through an intensity of a magnetic field generated by a coil 430.

The touch screen 190 displays an application for receiving, from a user, an input of data including at least one of handwriting, a text, and a picture, under control of the controller 110. The touch screen 190 may display the input data and one or more data, which is extracted to correspond to an analysis of the data input through the application, under the control of the controller 110. The touch screen 190 displays the number of the one or more extracted data at a partial area thereof under the control of the controller 110. The touch screen 190 may be divided into at least two areas, in which data may be input through one area, and the one or more extracted data may be displayed through another area in a descending order of a priority or a similarity. The area or boundary is changed in size under the control of the controller 110. The touch screen 190 displays, under the control of the controller 110, the merged data obtained by merging the input data and the one or more extracted data. The touch screen 190 may provide a movement of the data on the application under the control of the controller 110.

The touch screen controller 195 converts the analog signal received from the touch screen 190 to a digital signal (e.g., X and Y coordinates) and then transmits the digital signal to the controller 110. The controller 110 can control the touch screen 190 by using the digital signal received from the touch screen controller 195. For example, the controller 110 allows a short-cut icon (not shown) or an object displayed on the touch screen 190 to be executed in response to a touch event or a hovering event. Further, the touch screen controller 195 may be included in the controller 110.

Moreover, the touch screen controller 195 can identify the distance between a space for occurrence of a hovering interval and the touch screen 190 by detecting a value (e.g., a current value, or the like) output through the touch screen 190, convert the identified distance value to a digital signal (e.g., a Z coordinate), and then provide the converted digital signal to the controller 110.

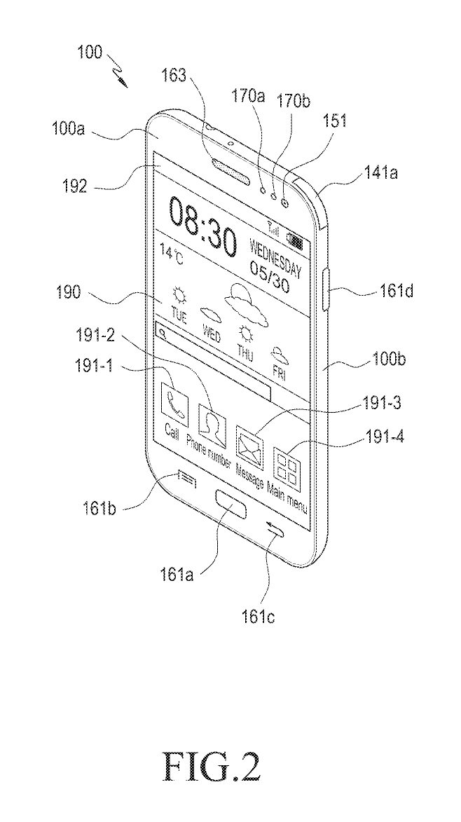

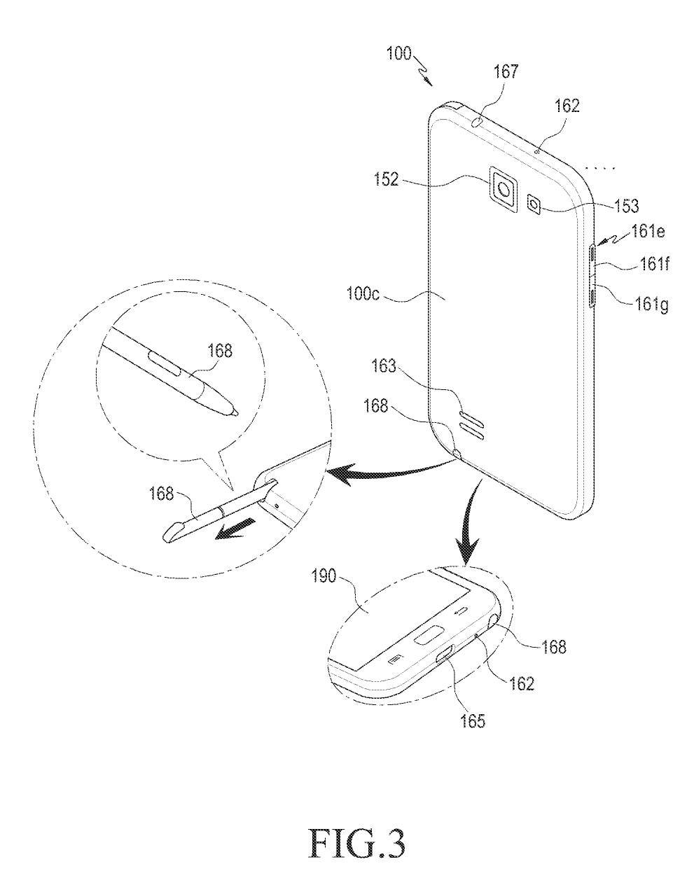

FIG. 2 illustrates a front perspective view of a portable terminal according to an embodiment of the present disclosure, and FIG. 3 illustrates a rear perspective view of a portable terminal according to an embodiment of the present disclosure.

Referring to FIGS. 2 and 3, the touch screen 190 is disposed on a center of a front surface 100a of the portable terminal 100. The touch screen 190 can have a large size to occupy most of the front surface 100a of the portable terminal 100. FIG. 2 illustrates an example in which a main home screen is displayed on the touch screen 190. The main home screen is a first screen displayed on the touch screen 190 when power of the portable terminal 100 is turned on. Further, when the portable terminal 100 has different home screens of several pages, the main home screen may be a first home screen of the home screens of several pages. Short-cut icons 191-1, 191-2, and 191-3 for executing frequently used applications, a main menu switching key 191-4, time, weather, and the like may be displayed on the home screen. The main menu switch key 191-4 displays a menu screen on the touch screen 190. At the top end of the touch screen 190, a status bar 192 may be formed that indicates the status of the mobile apparatus 100 such as the battery charge status, the intensity of a received signal, current time, and/or the like.

A home button 161a, a menu button 161b, and a back button 161c may be formed on a lower end of the touch screen 190.

The home button 161a displays the main home screen on the touch screen 190. For example, when the home key 161a is touched in a state in which a home screen different from the main home screen or the menu screen is displayed on the touch screen 190, the main home screen may be displayed on the touch screen 190. Further, when the home button 191a is touched while applications are executed on the touch screen 190, the main home screen illustrated in FIG. 2 may be displayed on the touch screen 190. In addition, the home button 161a may be used to display recently used applications or a task manager on the touch screen 190.

The menu button 161b provides a connection menu which can be displayed on the touch screen 190. The connection menu includes a widget addition menu, a background changing menu, a search menu, an editing menu, an environment setup menu, and the like.

The back button 161c can be used for displaying the screen which was executed just before the currently executed screen and/or for terminating the most recently used application.

The first camera 151, the illumination sensor 170a, and the proximity sensor 170b may be disposed on edges of the front surface 100a of the portable terminal 100. The second camera 152, the flash 153, and the speaker 163 may be disposed on a rear surface 100c of the portable terminal 100. According to various embodiments of the present disclosure, the speaker may be disposed on the front surface 100a of the portable terminal 100 and/or the rear surface 100c of the portable terminal 100.

A power/reset button 161d, a volume button 161e including a volume up button 161f and a volume down button 161g, a terrestrial DMB antenna 141a for broadcasting reception, and one or a plurality of microphones 162 may be disposed on a side surface 100b of the portable terminal 100. The DMB antenna 141a may be fixed to the portable terminal 100 or may be formed to be detachable from the portable terminal 100.

Further, the connector 165 is formed on a lower side surface of the portable terminal 100. A plurality of electrodes is formed in the connector 165, and the connector 165 can be connected to the external device through a wire. The earphone jack 167 may be formed on a side surface of an upper end of the portable terminal 100. Earphones may be inserted into the earphone jack 167.

Further, an input unit 168 may be mounted (e.g., mounted in removable relation to the portable terminal 100) to a side surface of a lower end of the portable terminal 100. The input unit 168 can be inserted into the portable terminal 100 to be stored in the portable terminal 100, and withdrawn and separated from the portable terminal 100 when the input unit 168 is used.

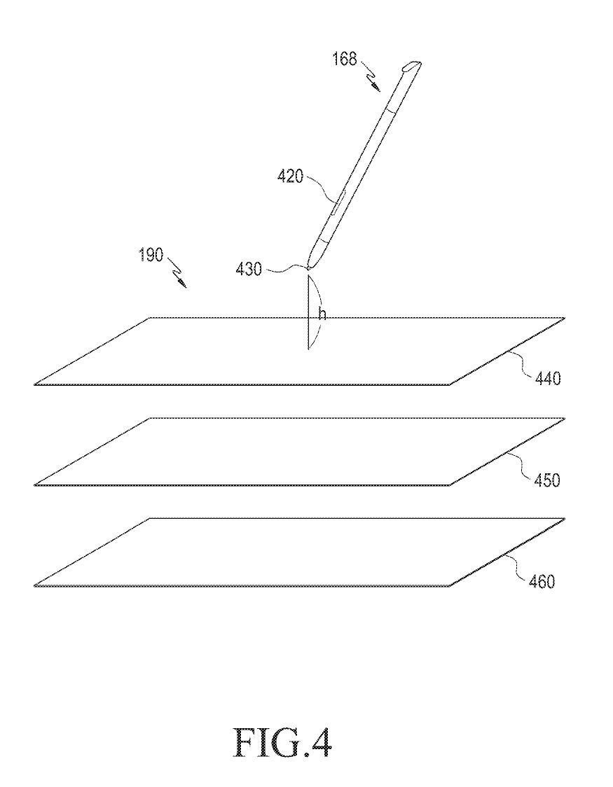

FIG. 4 illustrates an input unit and an internal structure of a touch screen according to an embodiment of the present disclosure.

Referring to FIG. 4, a touch screen 190 includes a first touch panel 440, a display panel 450, and a second touch panel 460. The touch screen 190 may include only the display panel 450, or may include the first touch panel 440, the display panel 450, and the second touch panel 460. The display panel 450 may be a panel such as a Liquid Crystal Display (LCD) panel, an Active Matrix Organic Light Emitting Diode (AMOLED) panel, and/or the like, and may display various operation statuses of a portable terminal 100, various images according to execution and a service of an application, a plurality of objects, a GUI, and/or the like.

The first touch panel 440 is a capacitive type touch panel, which is coated with a dielectric in which both sides of a glass are coated with a metal conductive material (e.g., an Indium Tin Oxide (ITO) film, and the like) so that the first touch panel 190b allows a current to flow in the glass surface and stores a charge. When a user's finger is touched on a surface of the first touch panel 440, a predetermined amount of electric charge moves to a touched location due to a static electricity, and the first touch panel 440 (e.g., the controller 110 and/or the touch screen controller 195) detects the touched location through recognizing a variation in a current according to the movement of the electric charge. All touches that may cause static electricity can be detected through the first touch panel 440.

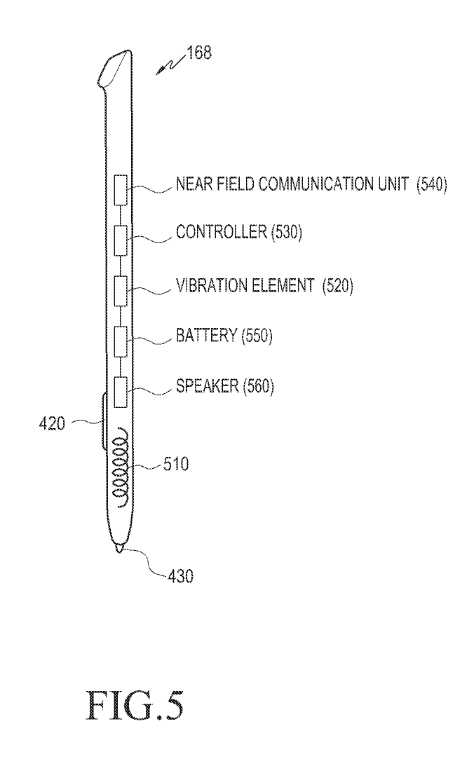

According to various embodiments of the present disclosure, the second touch panel 460 may be an Electro-Magnetic Resonance (EMR) type touch panel, which includes an electromagnetic induction coil sensor (not shown) having a grid structure including a plurality of loop coils arranged in a predetermined first direction and a second direction crossing the first direction and an electronic signal processor (not shown) for sequentially providing an AC signal having a predetermined frequency to each loop coil of the electromagnetic induction coil sensor. When the input unit 168 having a resonant circuit therein is located near the loop coil of the second touch panel 460, a magnetic field transmitted from the corresponding loop coil generates a current based on mutual electromagnetic induction to the resonant circuit within the input unit 168. An induction magnetic field is generated, based on the current, from a coil (not illustrated) that configures a resonance circuit in the interior of an input unit 168, the second touch panel 460 detects the induction magnetic field around the loop coil in a signal reception state to detect a hovering location or a touch location of the input unit 168, and a height (h) from the first touch panel 440 to a pen point 430 of the input unit 168. It will be readily understood by those skilled in the art to which the present disclosure pertains that the height (h) from the first touch panel 440 of the touch screen 190 to the pen point 430 may be varied to correspond to a performance, a structure, and/or confguration of the portable terminal 100. If an input unit may cause a current based on electromagnetic induction through the second touch panel 460, a hovering event and a touch can be detected, and it will be described that the second touch panel 460 may be used for detection of the hovering event or the touch by the input unit 168. According to various embodiments of the present disclosure, the second touch panel 460 may be used only for detection of the hovering event or the touch by the input unit 168. The input unit 168 may be referred to as an electromagnetic pen or an EMR pen. Further, the input unit 168 may be different from a general pen that does not include the resonance circuit detected through the first touch panel 440. The input unit 168 may include a button 420 that may vary an electromagnetic induction value generated by a coil that is disposed, in an interior of a penholder, adjacent to the pen point 430. The input unit 168 will be more specifically described below with reference to FIG. 5.

A touch screen controller 195 may include a first touch panel controller and a second touch panel controller. The first touch panel controller converts an analog signal, received from the first touch panel 440 through detection of a finger (or the like), into a digital signal (e.g., X, Y, and Z coordinates), and transmits the digital signal to the controller 110. The second touch panel controller converts an analog signal, received from the second touch panel 460 through detection of a hovering event or a touch of the input unit 168, into a digital signal, and transmits the digital signal to the controller 110. The controller 110 may control the first touch panel 440, the display panel 450, and the second touch panel 460 by using the digital signals received from the first and second touch panel controllers, respectively. For example, the controller 110 may display a screen in a predetermined form on the display panel 450 to respond to the hovering event or the touch of the finger, the pen, the input unit 168, and/or the like.

Thus, the first touch panel may detect the touch by the user's finger or the pen, and the second touch panel may detect the hovering event or the touch by the input unit 168 in the portable terminal 100 according to the various embodiments of the present disclosure. The controller 110 of the portable terminal 100 may differently detect the touch by the user's finger, the pen, and/or the like, and the hovering event or the touch by the input unit 168, and/or the like. While only one touch screen is illustrated in FIG. 4, the present disclosure may include a plurality of touch screens, without being limited thereto. The plurality of touch screens may be disposed in housings, respectively, and may be connected with each other by hinges, or the plurality of touch screens may be disposed in a single housing. The plurality of touch screens include the display panel and the at least one touch panel, as illustrated in FIG. 4.

FIG. 5 is a block diagram illustrating an input unit according to an embodiment of the present disclosure.

Referring to FIG. 5, according to varoius embodiments of the present disclosure, the input unit (e.g., a touch pen) 168 may include a penholder, a pen point 430 disposed at an end of the penholder, a button 420 that may vary an electromagnetic induction value generated by a coil 510 that is disposed, in an interior of the penholder, adjacent to the pen point 430, a vibration element 520 that vibrates when an hovering input effect is generated, a controller 530 that analyzes a control signal received from a portable terminal 100 due to the hovering over the portable terminal 100, and controls a vibration intensity and a vibration period of the vibration element 520 in order to provide, to the input unit 168, a haptic effect according to the analysis, a near field communication unit 540 that performs near field communication with the portable terminal 100, and a battery 550 that supplies an electrical power for a vibration of the input unit 168. Further, the input unit 168 may include a speaker 560 that outputs a sound corresponding to the vibration intensity and the vibration period of the input unit 168.

The input unit 168 having such a configuration as described above supports an electrostatic induction method. When a magnetic field is caused by the coil 510 at a predetermined point of the touch screen 190, a touch screen 190 may recognize a touch point through detecting a location of the corresponding magnetic field.

More specifically, the speaker 560 may output, under control of the controller 530, sounds corresponding to various signals (e.g., a wireless signal, a broadcasting signal, a digital audio file, a digital video file, and/or the like) that are received from a mobile communication module 120, a sub-communication module 130, and a multimedia module 140, which are installed in the portable terminal 100. Further, the speaker 560 may output sounds corresponding to functions that the portable terminal 100 performs (e.g., a button manipulation tone corresponding to a telephone call, a call connection tone, and/or the like), and one or a plurality of speakers 560 may be installed at a proper location or locations of a housing of the input unit 168.

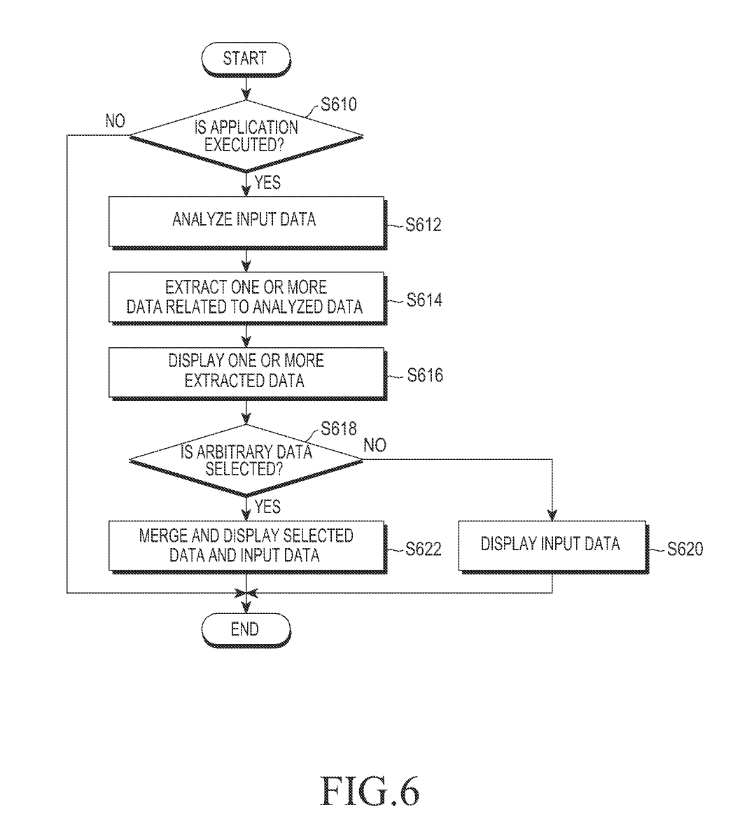

FIG. 6 is a flowchart illustrating a method of controlling data merging according to an embodiment of the present disclosure.

Hereinafter, a method of controlling the data merging according to an embodiment of the present disclosure will be specifically described with reference to FIG. 6.

Referring to FIG. 6, at operation S610, a determination is made as to whether an application is being executed.

If an application is determined as not being executed at operation S610, then the method of controlling the data merging may be terminated.

If an application is determined as being executed at operation S610, the method may proceed to operation S612 at which input data is analyzed. According to various embodiments of the present disclosure, at least one of handwriting, a text, and a picture may be input through the application through which a user may input the at least one of the handwriting, the text, the picture, and the like. According to various embodiments of the present disclosure, the application includes various programs, such as a memo application, a diary application, a note application, a word or document editing application, and the like, which can receive an input of at least one of handwriting, a text, and a picture. According to various embodiments of the present disclosure, at least one of the handwriting, the text, the picture, and the like which have been input through the application, is analyzed. In the analysis, when the input data is handwriting or a text that the user has directly made, at least one of a keyword, a passage, a tag, a portion of the handwriting, and the like is extracted, and when the input data is a picture that the user has directly drawn or a photo that has been stored in advance in a portable terminal, at least one of pixel information, a title, a time when the picture or the photo has been made, a place at which the picture or the photo has been made, and the like is extracted. In other words, when the input data is the picture which the user has directly drawn, at least one of pixels, a contour, a shape, and a size of the drawn picture is analyzed, and when the input data is the photo stored in advance in the portable terminal, a time when the photo has been taken, a place at which the photo has been taken, a title of the photo, and/or the like are analyzed. The portable terminal extracts, through the analysis result, data corresponding to the at least one of the handwriting, the text, the picture, and/or the like which have been input.

At operation S614, one or more data is extracted. For example, one or more data, which is related to the data analyzed at operation S612, is extracted.

At operation S616, the one or more extracted data, which is extracted at operation S14, is displayed. According to various embodiments of the present disclosure, one or more data stored in advance in the portable terminal is extracted to correspond to the analysis of the input data, and the one or more extracted data is displayed at a partial area of a touch screen. The number of the one or more extracted data is displayed at a partial area of the touch screen. Further, according to various embodiments of the present disclosure, the one or more extracted data may be displayed at a partial area of the touch screen to correspond to a selection or a click for the area at which the number is displayed. The one or more extracted data may be displayed on the touch screen, in which the extracted data whose keyword is the same as a keyword of the data input at operation S612 may be first displayed, and then the extracted data whose keyword is similar to the keyword of the data input at operation S612 may be displayed in a descending order of the similarity. When the input data is the handwriting or the text, the similarity is determined through the number of keywords, or when the input data is the picture which the user has directly drawn or the photo, the similarity is determined through at least one of the pixels, the contour, the shape, the size, the time when the photo has been taken, the place at which the photo has been taken, the title of the photo, and/or the like. The extracting of the one or more data and the displaying of the extracted data may be performed at a time point when the data has been completely input, or at a time point when the input data is stored. Further, according to various embodiments of the present disclosure, when the one or more data has been completely extracted, the number of the extracted data may be displayed on the touch screen. Further, when, as the analysis result of the input data, a plurality of data has similarities to the analyzed data which are higher than a threshold value set in advance, the user may extract a desired number of data by setting in advance a threshold value for the number of extracted data. Moreover, when, as the analysis result of the input data, the plurality of data has the similarities to the analyzed data which are higher than the threshold value set in advance, the number of extracted data may be adjusted through regulation of the similarities. At least one of functions for deleting the corresponding extracted data, merging the corresponding extracted data with the input data, and deleting the input data may be provided for each of the one or more extracted data, and the functions may be displayed at a partial area of the data which has been extracted for a user selection, or at a partial area of the touch screen. The one or more data may be displayed according to the similarity or a priority, and an order in which the one or more data is to be displayed may be changed by a user selection.

At operation S618, a determination is made as to whether an arbitrary data is to be selected.

If the arbitrary data is not determined to be selected at operation S618, then the method may proceed to operation S620, the input data is displayed. For example, when the arbitrary data is determined not to be selected by the user (e.g., while the one or more data has been extracted and displayed at operation S616 to correspond to the input data), then the method may proceed to opreation S620 at which the data (e.g., input at operation 612) is continuously displayed. While the one or more extracted data has been displayed in this case, the arbitrary data may not be selected by the user.

If the arbitrary data is determined to be selected at operation S618, then the method proceeds to operation S622 at which the selected data and the input data are merged and displayed. According to various embodiments of the present disclosure, at least one data selected from the one or more data displayed on the touch screen, and the data input at operation S612 are merged, and the merged result is displayed on the touch screen. According to various embodiments of the present disclosure, data corresponding to the merged result may be stored. The merging may be performed through a selection or an input of the function, for merging the corresponding displayed data with the input data, among the plurality of functions included in the one or more displayed data. The data selected at operation S618 may be merged at a location of a cursor at operation S612. According to various embodiments of the present disclosure, the location of the selected arbitrary data may be variably adjusted by the user.

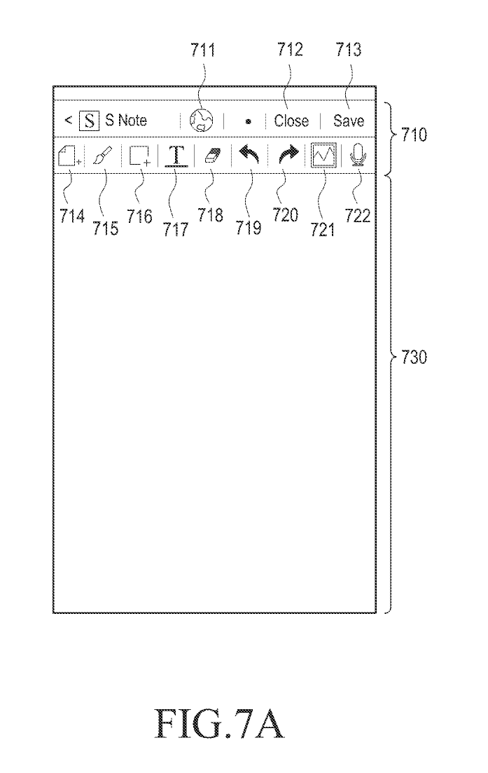

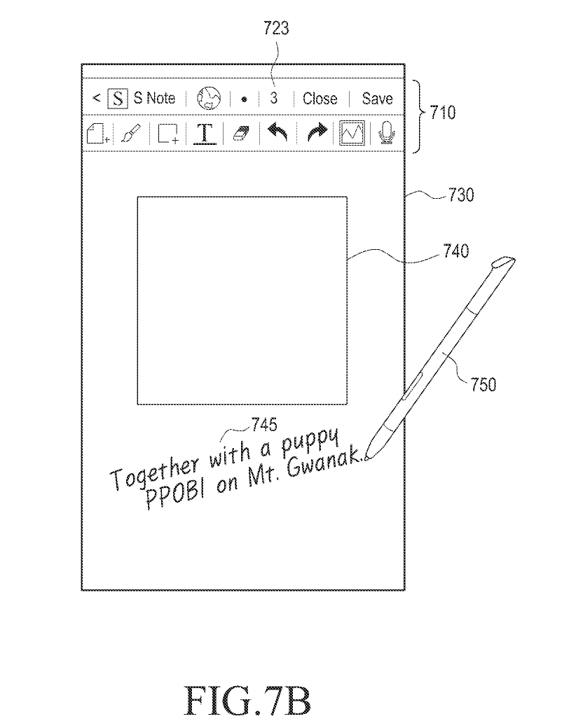

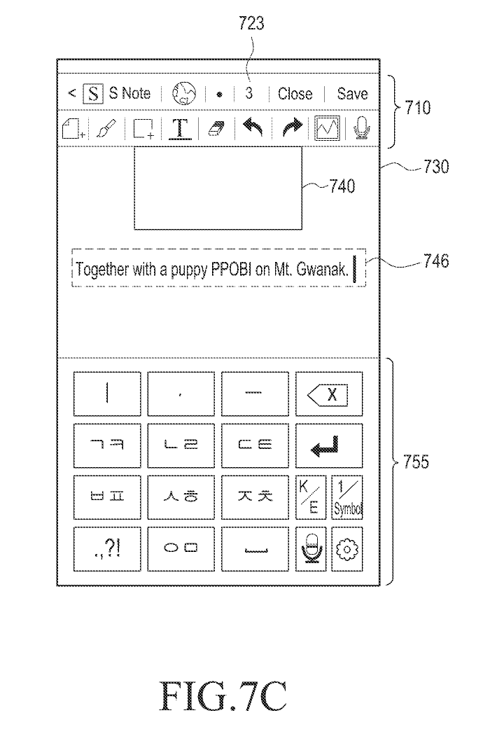

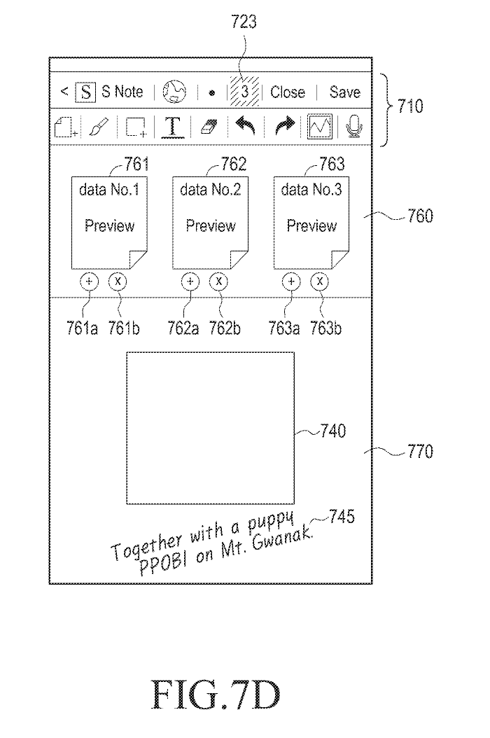

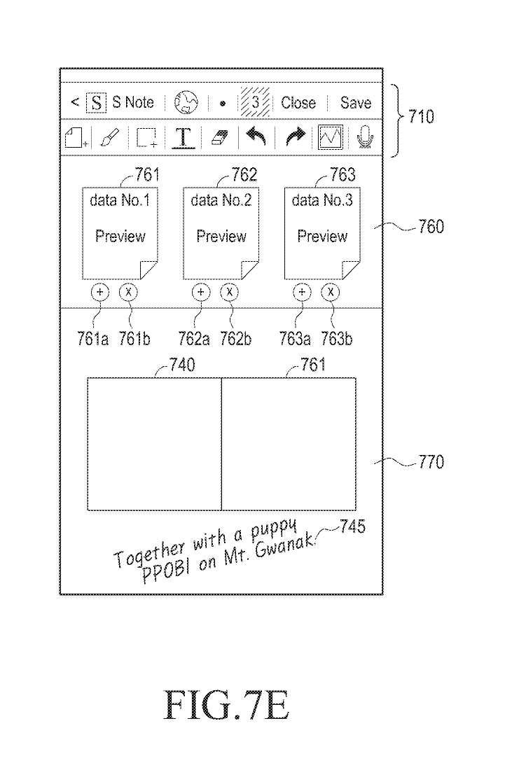

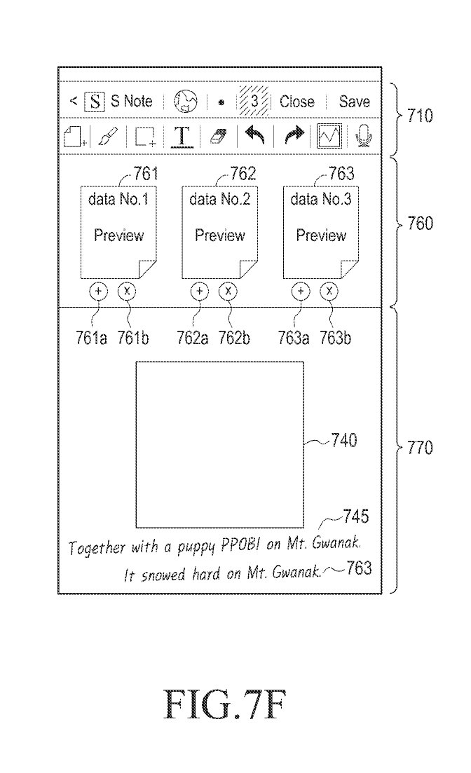

FIGS. 7A, 7B. 7C, 7D, 7E, and 7F illustrate examples of a process for controlling data merging according to various embodiments of the present disclosure.

Referring to FIGS. 7A to 7F, FIG. 7A illustrates an example of an application according to an embodiment of the present disclosure, FIG. 7B illustrates an example of a process for inputting data to an application according to an embodiment of the present disclosure, FIG. 7C illustrates an example of a process for inputting data to an application according to an embodiment of the present disclosure, FIG. 7D illustrates an example of a process for displaying one or more data corresponding to data input to an application according to an embodiment of the present disclosure, FIG. 7E illustrates an example of a process for adding an arbitrary picture to data input to an application according to an embodiment of the present disclosure, and FIG. 7F illustrates an example of a process for adding an arbitrary text to data input to an application according to an embodiment of the present disclosure.

FIG. 7A illustrates the example of the application according to an embodiment of the present disclosure. According to various embodiments of the present disclosure, the application includes various programs, such as a memo application, a diary application, a note application, and a word or document editing application, which can receive an input of handwriting and a picture. The application may be configured with a menu screen 710 that provides various functions, and an input screen 730 that receives an input of data. While the application configured with two screens has been illustrated in FIG. 7a, this is illustrative and the application according to various embodiments of the present disclosure may be configured with one or more screens. The menu screen 710 includes a function 711 for inputting map data, a function 712 for ending the application, a function 713 for storing input data, a function 714 for opening a new page, a function 715 for selecting a font or a color of input handwriting and an input text, a function 716 for selecting an area of input data, a function 717 for inputting a text to the input screen 730, a function 718 for erasing a portion or the whole of at least one of the input handwriting and the input text, a undo function 719, a redo function 720, a function 721 for inserting an image, a function 722 for inputting a voice, and the like. The functions provided by the application according to various embodiments of the present disclosure may include, in addition to the above-described various functions, various functions provided by document writing programs executed in a computer. The input screen 730 may receive an input of at least one data of handwriting, a text, a picture, a photo, a video, a voice, and the like, and may display the input data.

FIG. 7B illustrates an example of the process for inputting the data to the application according to an embodiment of the present disclosure. According to various embodiments of the present disclosure, the input screen 730 on the application may receive an input of at least one data of handwriting, a text, a picture, a photo, a video, a voice, and the like, and may display the input data.

Referring to FIG. 7B, the input screen 730 displays an object 740 such as a picture or a photo, and handwriting 745 that a user has directly made through an input unit 750. The object 740 may be a picture that a user has directly drawn through the input unit 750, or a picture or a photo that has been stored in advance in a portable terminal. The object 740 may include a target object (e.g., a puppy). The handwriting 745 may be handwriting that represents an additional description of the object 740. According to various embodiments of the present disclosure, a text may be input through a keypad to be displayed instead of the handwriting. A process for inputting the text through the keypad will be described below with reference to FIG. 7C.

When the data such as the handwriting, the text, and the picture are input to input screen 730 as described above, the input data is analyzed and one or more data corresponding to the analysis is extracted from a storage unit. For example, as illustrated in FIG. 7B, when the handwriting input to the input screen 730 is ‘Together with a puppy PPOBI on Mt. Gwanak. (Korean)’, one or more data among keywords (e.g., ‘Mt. Gwanak’, ‘puppy’, and ‘PPOBI’ (Korean)) of the input handwriting, and a contour, a shape, a size, a photographing time, a photographing place, and a title of the input object 740 is extracted.

The number of the one or more extracted data may be displayed at a partial area of the touch screen or at a partial area 723 of the menu screen 710. The extracted data may be more specifically viewed through selecting the displayed area 723. While only three extracted data has been illustrated in FIG. 7B, this is merely illustrative. According to various embodiments of the present disclosure, one or more data may be extracted, and, in addition, a numeral corresponding to the number of the extracted data may be displayed.

FIG. 7C illustrates an example of the process for inputting the data to the application according to an embodiment of the present disclosure. According to various embodiments of the present disclosure, a text may be input to a text window 746 through a key pad 755, and may be displayed in the input screen 730. The input screen 730 displays the object 740 such as a picture or a photo, and the keypad 755 through which the text is input to the text window 746. The input screen 730 displays, in the text window 746, the text input through the displayed keypad 755. The keypad 755 may disappear on the input screen 730 when the text is completely input. The text input to the text window 746 may be a text representing an additional description of the object 740.

FIG. 7D illustrates an example of a process for displaying one or more data corresponding to data input to an application according to an embodiment of the present disclosure. According to various embodiments of the present disclosure, when the displayed area 723 of FIG. 7B is selected or the input data is completely analyzed, the portable terminal may divide the screen of the touch screen into an input screen 770 that receives an input of data, and a display screen 760 that displays the one or more data extracted to correspond to the analysis of the data input to the input screen. A location and a size of the input screen 770 and the display screen 760 may be variably adjusted (e.g., according to user and/or manufacturer preferences or settings). The location and size of the input screen 770 and the display screen 760 may be automatically adjusted according to the amount of data input to the input screen 770 and/or the number of extracted data displayed in the display screen 760. The display screen 760 displays the data extracted in the process of FIG. 7B. For example, the display screen 760 displays one or more data corresponding to one or more of the keywords (e.g., ‘Mt. Gwanak’, ‘puppy’, and ‘PPOBI’ (Korean)) which can be extracted from the input handwriting, and the contour, the shape, the size, the photographing time and place, and the title, which can be extracted from the input object 740. While the display screen 760 displays only three data 761, 762, and 763 related to the input screen 770, this is merely illustrative. According to various embodiments of the present disclosure, one or more data may be displayed. The one or more data has a similarity to the data 740 input to the input screen 770. For example, the first data 761 has similarity to at least one of a target object (e.g., a puppy) included in the object 740 of the input screen 770, and keywords extracted from the input handwriting 745 (e.g., ‘puppy’ and ‘PPOBI’ (Korean)). The second data 762 has similarity to target objects (e.g., a puppy and Mt. Gwanak) included in the object 740 of the input screen 770, and a keyword extracted from the input handwriting 745 (e.g., at least one of ‘Mt. Gwanak’, ‘puppy’, and ‘PPOBI’ (Korean)). The third data 763 has similarity to at least one of a target object (e.g., Mt. Gwanak) included in the object 740 of the input screen 770, and a keyword extracted from the input handwriting 745 (e.g., ‘Mt. Gwanak (Korean)’). The data is generally similar or related to the input object, and may include a video, a photo, a picture, a text, and a name of an object. In addition, a location at which the related data has been stored may be displayed.

The one or more extracted data (e.g., first data 761, second data 762, and third data 763) may be the same as or similar to at least one of a keyword, a passage, a tag, a portion of handwriting, and a contour, a shape, a size, a photographing time, a photographing place, a title of the objects 740, and the like which are extracted from the data input to the input screen 770. The first data 761 includes an addition function 761a for adding the first data to the data input to the input screen 770, and a deletion function 761b for deleting the first data in the display screen 760. The second data 762 includes an addition function 762a for adding the second data to the data input to the input screen 770, and a deletion function 762b for deleting the second data in the display screen 760. The third data 763 includes an addition function 763a for adding the third data to the data input to the input screen 770, and a deletion function 763b for deleting the third data in the display screen 760.

FIG. 7E illustrates an example of a process for adding an arbitrary picture to data input to an application according to an embodiment of the present disclosure. According to various embodiments of the present disclosure, when the first data 761 is selected in the display screen 760 of FIG. 7D, the input screen 770 adds (or merges) the first data 761 selected in the process of FIG. 7D to the data 740 and 745 input in the process of FIG. 7B, and displays the merged data. For example, the input screen 770 of FIG. 7E adds the first data 761 to the data 740 and 745 input in the process of FIG. 7B and displays the merged data, and the first data 761 may be added to any location of the input screen 770. While the first data 761 is located at a right side of the object 740 and on an upper side of the input handwriting 745, this is merely illustrative. According to various embodiments of the present disclosure, the first data 761 may be moved to an arbitrary location of the input screen 770. Attributes of the first data 761, the object 740, and the handwriting 745 may be changed through control of the various functions of the menu screen 710. The first data 761 is the same as or similar to the data input in the process of FIG. 7B, in at least one of a keyword, a passage, a tag, a portion of handwriting, a contour, a shape, a size, a photographing time, a photographing place, a title, and the like.

FIG. 7F illustrates an example of a process for adding an arbitrary text to a data input to an application according to an embodiment of the present disclosure. According to various embodiments of the present disclosure, when the third data 763 is selected in the display screen 760 of FIG. 7D, the input screen 770 adds the first data 761 selected in the process of FIG. 7D to the data input in the process of FIG. 7B, and displays the merged data. For example, the input screen 770 of FIG. 7F adds the first data 761 to the data 740 and 745 input in the process of FIG. 7B and displays the merged data. For example, when the third data 763 corresponds to a text (e.g., ‘It snowed hard on Mt. Gwanak. (Korean)’) having a similarity to the input data 740, the third data 763 is displayed while being added to the input data 745. The third data 763 may be added to any location of the input screen 770. While the third data 763 is located on a lower side of the input handwriting 745, this is merely illustrative. According to various embodiments of the present disclosure, the third data 763 may be moved to an arbitrary location of the input screen 770. Attributes of the third data 763, the object 740, and the handwriting 745 may be changed through control of the various functions of the menu screen 710. The third data 763 is the same as or similar to the data input in the process of FIG. 7B, in at least one of a keyword, a passage, a tag, a portion of handwriting, and the like.

Although the touch screen has been illustrated as a representative example of the display unit displaying the screen in the above-described various embodiments, a general display unit, such as a Liquid Crystal Display (LCD), an Organic Light Emitting Diode (OLED), a Light Emitting Diode (LED), and the like, which do not have a touch detection function may also be used instead of the touch screen.

It may be appreciated that the various embodiments of the present disclosure can be implemented in software, hardware, or a combination thereof. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It will be appreciated that a memory, which may be incorporated in a portable terminal, may be an example of a non-transitory machine-readable (e.g., computer-readable) storage medium which is suitable for storing a program or programs including commands to implement the various embodiments of the present disclosure. Therefore, various embodiments of the present disclosure provide a program including codes for implementing a system or method claimed in any claim of the accompanying claims and a machine-readable device for storing such a program. Moreover, such a program as described above can be electronically transferred through an arbitrary medium such as a communication signal transferred through cable or wireless connection, and the present disclosure properly includes the things equivalent to that.

Moreover, the above-described mobile terminal can receive the program from a program provision device which is connected thereto in a wired or wireless manner, and store the program.

The program providing apparatus may include a program that includes commands for controlling data merging of the portable terminal, a memory or a storage unit that stores information necessary for providing the data merging to a user by the portable terminal, a communication unit that performs a wired or wireless communication with the portable terminal, and a controller that transmits the corresponding program to the host device according to a request of the portable terminal or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling data merging of a portable terminal, the method comprising:
analyzing input data;
extracting and displaying one or more data corresponding to the analyzed input data; and
merging at least one data selected from the one or more displayed data and the input data.

2. The method of claim 1, further comprising:
displaying the merged data.

3. The method of claim 1, wherein the one or more extracted data is displayed in a descending order of a similarity to the input data.

4. The method of claim 3, wherein the similarity is determined through at least one of a keyword, a passage, a tag, a portion of handwriting, a picture attribute, and a place at which the data is input, the at least one of which is extracted from the input data.

5. The method of claim 1, wherein the analyzing of the input data comprises:
extracting, from the input data, one or more of a keyword, a passage, a tag, a portion of handwriting, a picture attribute, and a place.

6. The method of claim 1, wherein the one or more extracted data is displayed if the input data is completely analyzed or the data is completely input.

7. The method of claim 1, wherein the displaying of the one or more data comprises:
displaying a number of the one or more extracted data.

8. The method of claim 1, wherein at least one of functions for deleting the corresponding displayed data, for merging the corresponding displayed data with the input data, and for deleting the input data is provided for the one or more displayed data.

9. The method of claim 1, further comprising:
executing an application for receiving an input of the data.

10. A method of controlling data merging of a portable terminal, the method comprising:
executing an application for receiving an input of at least one data of handwriting and a picture;
analyzing the data input to the executed application;
extracting one or more data in a descending order of a similarity to the input data to correspond to the analysis; and
controlling merging of the input data and the one or more extracted data.

11. The method of claim 10, further comprising:
displaying the merged data.

12. The method of claim 10, wherein the controlling of the merging comprises at least one of merging the input data and the one or more extracted data, deleting the one or more extracted data, and deleting the input data.

13. The method of claim 10, wherein the one or more extracted data is the same as or similar to at least one of a keyword, a passage, a tag, a portion of handwriting, a picture attribute, a place at which the data is input, the at least one of which is extracted from the input data.

14. The method of claim 13, wherein the similarity is determined through at least one of the keyword, the passage, the tag, the portion of the handwriting, the picture attribute, and the place at which the data is input, the at least one of which has been extracted.

15. The method of claim 10, further comprising:
displaying a number of the one or more extracted data.

16. The method of claim 10, further comprising:
displaying the one or more extracted data.

17. The method of claim 16, wherein at least one of functions for deleting the corresponding displayed data, for merging the corresponding displayed data with the input data, and for deleting the input data is provided for the one or more displayed data.

18. The method of claim 10, wherein the one or more extracted data is to be moved on the application.

19. A portable terminal for controlling data merging, the portable terminal comprising:
a display unit configured to display an application for receiving an input of at least one data of handwriting and a picture, and data input to the application; and
a controller configured to analyze the input data, to extract one or more data corresponding to the analyzed data, and to control merging of the input data and the extracted data.

20. The portable terminal of claim 19, further comprises:
a storage unit configured to store the one or more data corresponding to the analyzed data, and the merged data.

21. The portable terminal of claim 19, wherein the controller displays a screen of the display unit, by dividing the screen into an area that displays the one or more extracted data and an area that displays the input data.

22. The portable terminal of claim 19, wherein the display unit displays the one or more extracted data in combination with the input data.

23. The portable terminal of claim 20, wherein the controller extracts, through analyzing the input data, the one or more data having a high similarity to the data input from the storage unit.

24. The portable terminal of claim 22, wherein the similarity is determined through at least one of a keyword, a passage, a tag, a portion of handwriting, a picture attribute, and a place where the data is input, the at least one of which is extracted from the input data.

25. The portable terminal of claim 22, wherein the controller recognizes the input handwriting as a text, and extracts handwriting corresponding to the recognized text from the storage unit.

26. The portable terminal of claim 22, wherein the controller analyzes an attribute of the input picture, and extracts a picture corresponding to the analyzed attribute from the storage unit.

27. The portable terminal of claim 19, wherein the touch screen displays the number of the one or more extracted data.

28. The portable terminal of claim 19, wherein the controller transforms the handwriting input to the application to a text, analyzes an attribute of the picture input to the application, and stores the handwriting and the picture.

29. The portable terminal of claim 28, wherein the attribute of the picture comprises at least one of a title of the picture, a date if the picture has been drawn, a place at which the picture has been drawn, an object attribute included in the picture, and information on pixels configuring the picture.

30. The portable terminal of claim 19, wherein the application comprises a memo application, a diary application, a note application, and a word or document editing application, which are executed in the portable terminal and which are to make the handwriting and the picture.

31. A non-transitory computer-readable storage medium storing instructions that, when executed, cause at least one processor to perform the method of claim 1.

32. A non-transitory computer-readable storage medium storing instructions that, when executed, cause at least one processor to perform the method of claim 10.

33. A method of controlling data merging of a portable terminal, the method comprising:
receiving input data;
extracting at least one item stored on the portable terminal according to an extent to which the at least one item is similar to the received input data;
displaying the at least one extracted item and the input data; and
associating at least one of the at least one extracted item with the input data according to user selection.

34. A non-transitory computer-readable storage medium storing instructions that, when executed, cause at least one processor to perform the method of claim 33.
